(19) United States
(12) Patent Application Publication
(10) Pub. No.: US 2024/0100395 A1
(43) Pub. Date: Mar. 28, 2024

(54) MOTION ASSIST APPARATUS AND EXERCISE APPARATUS HAVING COLOR CHANGE FUNCTION USING ELECTRONIC INK

(71) Applicant: Samsung Electronics Co., Ltd., Suwon-si (KR)

(72) Inventors: Jaehong KIM, Suwon-si (KR); Sungchan KO, Suwon-si (KR); Seungyong HYUNG, Suwon-si (KR)

(21) Appl. No.: 18/456,919

(22) Filed: Aug. 28, 2023

Related U.S. Application Data
(63) Continuation of application No. PCT/KR2023/011023, filed on Jul. 28, 2023.

(30) Foreign Application Priority Data
Sep. 27, 2022 (KR) 10-2022-0122327
Dec. 15, 2022 (KR) 10-2022-0175943

(51) Int. Cl. A63B 24/00; A61H 1/02; A61H 3/00; A63B 71/06; G09G 3/00; G09G 3/38

(52) U.S. Cl. CPC A63B 24/0062; A61H 1/0244; A61H 3/00; A63B 71/0622; G09G 3/035; G09G 3/38; A61H 2003/007; A61H 2201/163; A61H 2201/1642; A61H 2201/1652; A61H 2201/5043; A61H 2201/5069; A61H 2201/5084; A61H 2230/06; A61H 2230/50; A63B 2024/0068; A63B 2220/50; A63B 2220/836; G09G 2320/0666; G09G 2330/021; G09G 2354/00

(57) ABSTRACT

A motion assist apparatus having a color change function using electric ink may include a waist frame and a waist belt that are to be worn on a waist of a user, a force transmission frame and a thigh belt that are to be worn on a thigh of the user, an actuator connected to the waist belt and configured to generate power, a drive frame connected to the actuator and configured to transmit the power to the force transmission frame, an input unit configured to detect at least one of exercise information of the user, body information of the user, and clothing information of the user, a color indicator including a first electrode layer disposed on the drive frame, an electronic ink layer disposed on the first electrode layer, and a second electrode layer disposed on the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

### CROSS-REFERENCE TO RELATED APPLICATIONS

This application is a continuation application of International Application No. PCT/KR2023/011023 designating the United States, filed on Jul. 28, 2023, in the Korean Intellectual Property Receiving Office and claiming priority to Korean Patent Application No. 10-2022-0122327, filed on Sep. 27, 2022, and Korean Patent Application No. 10-2022-0175943, filed on Dec. 15, 2022, in the Korean Intellectual Property Office, the disclosures of which are incorporated by reference herein in their entireties.

### BACKGROUND

### 1. Field

Certain example embodiments relate to a motion assist apparatus and/or an exercise apparatus, having a color change function that may use electronic ink.

### 2. Description of Related Art

In a rapidly aging society, a growing number of people experience inconvenience and pain from joint problems, and interest in an assist apparatus for assisting elderly users and patients in walking with ease, and/or for assisting any users with exercise and/or walking, has increased. A motion assist apparatus, for an arm(s) and/or leg(s) of a user, may also be worn to help increase muscular strength of a certain body part(s).

### SUMMARY

According to example embodiment, a motion assist apparatus having a color change function using electric ink may include a waist frame and a waist belt that are worn on a waist of a user, a force transmission frame and a thigh belt that are worn on a thigh of the user, an actuator connected, directly or indirectly, to the waist frame and configured to generate power, a drive frame connected, directly or indirectly, to the actuator and configured to transmit the power to the force transmission frame, an input unit configured to detect at least one of exercise information of the user, body information of the user, and clothing information of the user, a color indicator including a first electrode layer disposed on, directly or indirectly, the drive frame, an electronic ink layer disposed on, directly or indirectly, the first electrode layer, and a second electrode layer disposed on, directly or indirectly, the electronic ink layer, so that the electronic ink layer is located between at least the first electrode layer and the second electrode layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

According to an example embodiment, an exercise apparatus having a color change function using electronic ink may include a wearable module worn on an upper body of a user, a cable connected, directly or indirectly, to the wearable module, an input unit configured to detect at least one of body information of the user, clothing information of the user, and information about tension applied to the cable, a color indicator including a first electrode layer disposed on, directly or indirectly, the wearable module, an electronic ink layer disposed on, directly or indirectly, the first electrode layer, and a second electrode layer disposed on, directly or indirectly, the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

According to an example embodiment, an electronic device having a color change function using electronic ink may include a main body, an input unit configured to detect at least one of a driving state of the electronic device, a surrounding environment of the electronic device, and information about a preferred color of a user, a color indicator including a first electrode layer disposed on, directly or indirectly, the main body, an electronic ink layer disposed on, directly or indirectly, the first electrode layer, and a second electrode layer disposed on, directly or indirectly, the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a perspective view schematically illustrating an electronic device having a color change function using electronic ink, according to an example embodiment;

FIG. 2 is a block diagram schematically illustrating a color changing mechanism of an electronic device according to an example embodiment;

FIG. 3 is a cross-sectional view illustrating a color indicator, a main body, and a transparent cover according to an example embodiment;

FIG. 4 is a cross-sectional view illustrating a color indicator, a main body, an edge cover, and a transparent cover according to an example embodiment;

FIGS. 5 and 6 are cross-sectional views illustrating electronic ink layers according to an example embodiment;

FIG. 7 is a diagram illustrating a synthesized color of cyan, magenta, and yellow according to an example embodiment;

FIG. 8 is a perspective view illustrating a user wearing a motion assist apparatus according to an example embodiment;

FIG. 9 is a perspective view illustrating a drive frame body, a drive frame cover, and a color indicator according to an example embodiment;

FIG. 10 is a block diagram schematically illustrating an actuator control mechanism and a color change mechanism of a motion assist apparatus, according to an example embodiment;

FIG. 11 is a block diagram schematically illustrating a configuration of an input unit according to an example embodiment;

FIG. 12 is a perspective view illustrating a user wearing a motion assist apparatus according to an example embodiment;

FIG. 13 is a block diagram schematically illustrating an actuator control mechanism and a color change mechanism of an exercise apparatus, according to an example embodiment; and

FIG. 14 is a block diagram schematically illustrating a configuration of an input unit according to an example embodiment.

### DETAILED DESCRIPTION

The following detailed structural or functional description is provided as an example only and various alterations and modifications may be made to the examples. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the embodiments described above and an element having a common function. Unless otherwise mentioned, the descriptions of the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like constituent elements and a repeated description related thereto will be omitted.

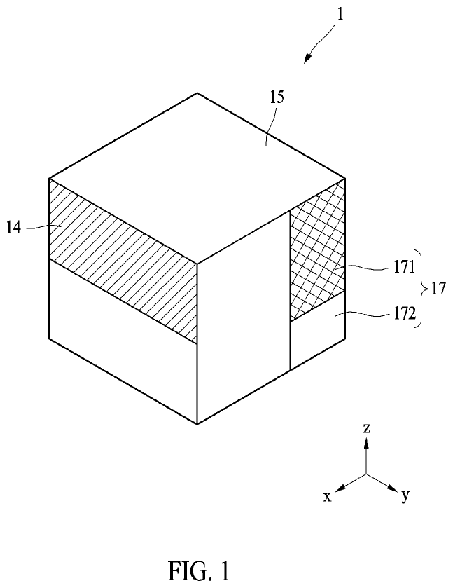

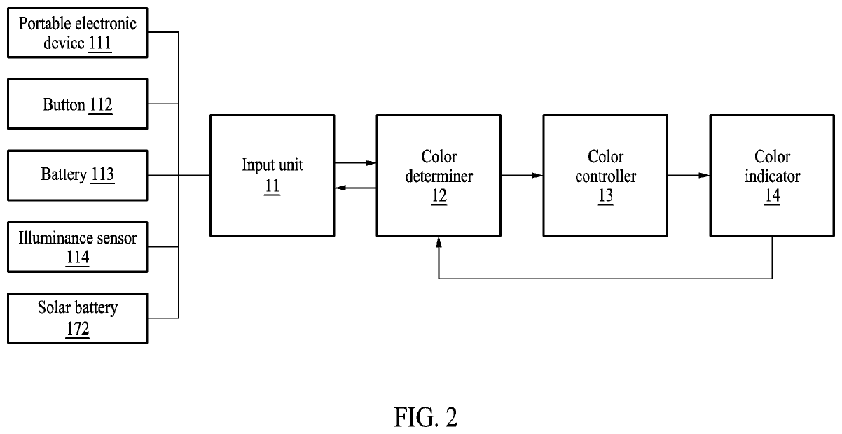

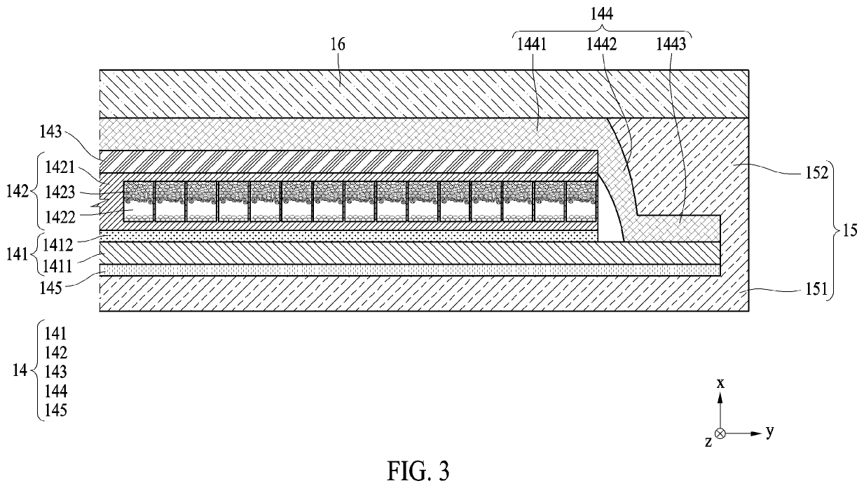

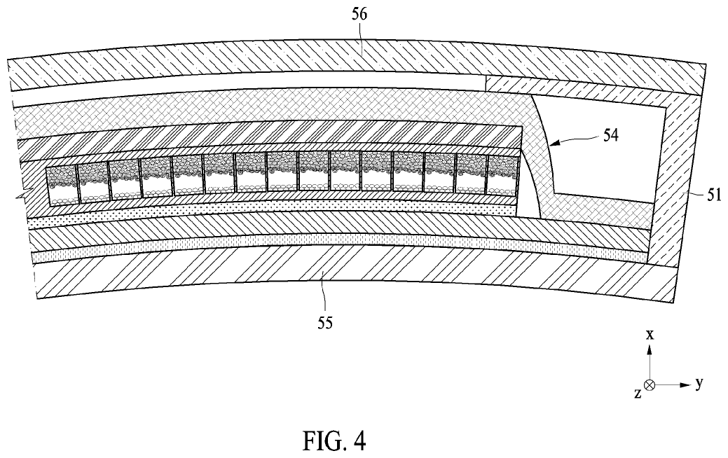

FIG. 1 is a perspective view schematically illustrating an electronic device having a color change function using electronic ink, according to an embodiment. FIG. 2 is a block diagram schematically illustrating a color changing mechanism of an electronic device according to an embodiment. FIG. 3 is a cross-sectional view illustrating a color indicator, a main body, and a transparent cover according to an embodiment. FIG. 4 is a cross-sectional view illustrating a color indicator, a main body, an edge cover, and a transparent cover according to an embodiment.

Referring to FIGS. 1 to 4, an electronic device 1 (hereinafter, referred to as “electronic device”) having a color change function using electronic ink according to an embodiment may change the color of a color indicator 14 to a target color according to a driving state, surrounding environment, and user's settings of the electronic device 1. Here, the electronic device 1 may include large home appliances, such as a washing machine and a refrigerator, and also small home appliances, such as a mobile phone, and may further include a movable robot using power. The color of the electronic device 1 may change to a target color such that the user may intuitively determine the driving state of the electronic device 1 and be satisfied with the design of the electronic device 1. The sense of use of the electronic device 1 may increase. The electronic device 1 may include an input unit 11 comprising circuitry and/or at least one sensor, a color determiner 12 comprising circuitry, a color controller 13 comprising circuitry and/or at least one sensor, and a color indicator 14.

In an embodiment, the input unit 11 may detect at least one of the surrounding environment of the electronic device 1 and information about the user's preferred color. The input unit 11 may transmit detected information to the color determiner 12. For example, the input unit 11 may include one or more of a portable electronic device 111, a button 112 connecting to a main body 15, a battery 113, and an illuminance sensor 114. Here, the main body 15 may be a component forming the skeletal system and exterior of the electronic device 1. For example, when the user presses the button 112 designating a specific driving mode of the electronic device 1, applicable information may be transmitted to the color determiner 12.

In an embodiment, the input unit 11, similar to the battery 113 and the illuminance sensor 114, and the like, may detect information about the driving state and surrounding environment of the electronic device 1 without the user's intervention. For example, the battery 113 may detect information about remaining battery power of the electronic device 1. For example, the illuminance sensor 114 may detect information about brightness of where the electronic device 1 is.

In an embodiment, based on information received from the input unit 11, the color determiner 12 may determine a target color corresponding to the information. The color determiner 12 may be inside or outside the main body 15. In an embodiment, when the color determiner 12 determines that the electronic device 1 is in a relatively bright place based on the information about the brightness detected by the illuminance sensor 114, the color determiner 12 may determine a target color having a relatively bright tone. When the user directly inputs a desired target color to the input unit 11, the target color determined by the color determiner 12 may be understood as the color directly input by the user.

In an embodiment, the color determiner 12 may immediately receive information from the input unit 11 comprising circuitry and/or at least one sensor. For example, when the electronic device 1, such as a washing machine, is driven through several operations, the color determiner 12 may immediately receive information corresponding to each of the operations from the input unit 11. The color determiner 12 may determine a different target color according to each of the operations. The color determiner 12 may transmit information about the determined target color to the color controller 13.

In an embodiment, the color controller 13 may control the color indicator 14 such that the color indicator 14 may indicate the target color determined by the color determiner 12. The color controller 13 may be inside or outside the main body 15. In an embodiment, the color controller 13 may change the color of the color indicator 14 by controlling the level of a voltage applied to the color indicator 14. After the color changes in the color indicator 14, information about the target color indicated by the color indicator 14 may be transmitted to the input unit 11 through the color determiner 12.

In an embodiment, electronic ink may be inside the color indicator 14. As a plurality of color particles 1423 having the same color moves toward a surface visible to the user, the color indicator 14 may indicate the color that the color particles 1423 have. As the color particles 1423 having different colors move together, the color indicator 14 may indicate a mixed color. The color indicator 14 may include a first electrode layer 141, an electronic ink layer 142, a second electrode layer 143, and a protection layer 144.

In an embodiment, the first electrode layer 141 may be in the main body 15 and apply a voltage to one surface of the electronic ink layer 142. The first electrode layer 141 may include a substrate layer 1411 and an application layer 1412. The first electrode layer 141 may be of or include ITO or any other suitable conductive material (e.g., Cr, Cu, Ag, TiN, tin oxide, or the like) in certain example embodiments.

In an embodiment, the substrate layer 1411 may be formed of a flexible material. For example, the substrate layer 1411 may be formed of a thin material, such as a polyethylene terephthalate (PET) film. The application layer 1412 may be applied to the substrate layer 1411. The application layer 1412 may be formed of a conductive material. For example, the application layer 1412 may be formed of conductive tape. For example, the application layer 1412 may be formed of conductive ink, such as carbon ink or silver inclusive ink. The conductive ink may be applied to the substrate layer 1411 via silk screen printing. When conductive tape or conductive ink is used instead of a metal electrode, the thickness of the first electrode layer 141 may reduce.

In an embodiment, the color indicator 14 may include a flexible material, so that the color indicator 14 may be not only on a flat portion of the main body 15 and on a curved portion of the main body 15. Compared to a conventional case of using a thin film transistor (TFT) backplane for the first electrode layer 141, the color indicator 14 may have a two-dimensional (2D) shape as well as a three-dimensional (3D) shape. The color indicator 14 may also have a perforated structure including holes. The color indicator 14 may be flexibly disposed even on the main body 15 having a large curvature. The utilization of the color indicator 14 may increase.

In an embodiment, the electronic ink layer 142 may be on the first electrode layer 141 and may indicate at least four colors. The second electrode layer 143 may be on the electronic ink layer 142. The second electrode layer 143 may apply a voltage to the other surface of the electronic ink layer 142. The color of the electronic ink layer 142 may be changed by using the principle of electrophoresis.

In an embodiment, the color of the color indicator 14 may also be changed by changing the color of the electronic ink layer 142 based on the surface where the user faces the color indicator 14. Here, a direction in which the user faces the color indicator 14 may be a −x direction. The second electrode layer 143 may be formed of a transparent material so as not to interfere with the color of the electronic ink layer 142. For example, the second electrode layer 143 may be Indium Tin Oxide (ITO) of a transparent conductive layer having electrical conductivity, or any other suitable conductive material which may be transparent in certain example embodiments. The electronic ink layer 142 may include a frame 1421, a transparent fluid 1422, and a plurality of color particles 1423 having different colors.

In an embodiment, the frame 1421 may be between the first electrode layer 141 and the second electrode layer 143. The frame 1421 may have a plurality of partitioned spaces. The transparent fluid 1422 and the plurality of color particles 1423 may be accommodated in each space partitioned in the frame 1421. The color particles 1423 may be electrically charged. When voltages are applied to the first electrode layer 141 and the second electrode layer 143, the color particles 1423 may move. The color indicator 14 may indicate a color that the color particles 1423 closest to the second electrode layer 143 have.

Herein, the frame 1421 is described as an integral structure having a plurality of partitioned spaces but the structure of the frame 1421 is not necessarily limited thereto. For example, a frame included in electronic ink may have a structure, such as microcups, microcapsules, and the like. That is, electronic ink having an arbitrary structure may be included in the electronic ink layer 142.

In an embodiment, the protection layer 144 may be on the second electrode layer 143. For example, the protection layer 144 may be formed of a flexible and transparent plastic material. The protection layer 144 may wrap around the electronic ink layer 142 and the second electrode layer 143. From such a structure, the protection layer 144 may prevent or reduce a chance of the electronic ink layer 142 from being exposed to moisture or foreign substances. Durability of the electronic ink layer 142 may increase.

In an embodiment, the protection layer 144 may include a top layer 1441 stacked on the second electrode layer 143, a middle layer 1442 extending from the top layer 1441 toward the substrate layer 1411, and a base layer 1443 extending from the middle layer 1442 and stacked on the substrate layer 1411. From such a structure, the middle layer 1442 and the base layer 1443 may be formed along the edge of the electronic ink layer 142. That is, the middle layer 1442 and the base layer 1443 may be portions not related to color change of the electronic ink layer 142. The middle layer 1442 and the base layer 1443 may be processed so as not to deteriorate the appearance of the color indicator 14.

In an embodiment, the middle layer 1442 and the base layer 1443 may be covered by the main body 15 without additional processing. For example, as shown in FIG. 3, the main body 15 may include a base body 151 on the side opposite to the electronic ink layer 142 based on the first electrode layer 141 and may include a cover body 152 extending from the base body 151. The base layer 1443 may be inserted into a groove between the base body 151 and the cover body 152.

In an embodiment, a barrier layer 145 may be additionally disposed between the base body 151 and the substrate layer 1411. The barrier layer 145 may prevent or reduce a chance of the substrate layer 1411 from being damaged by friction with the base body 151. For example, the barrier layer 145 may be formed of the same material as the protection layer 144.

In an embodiment, a transparent cover 16 may be additionally disposed on, directly or indirectly, the color indicator 14. The color indicator 14 may be covered by the main body 15 and the transparent cover 16. The transparent cover 16 may prevent or reduce a chance of the color indicator 14 from being damaged by an external force or prevent or reduce a chance of the surface of the color indicator 14 from being scratched by contact with foreign substances.

In an embodiment, when the color indicator 14 is on the main body 15 having a flat surface, as shown in FIG. 3, the transparent cover 16 may be formed of a material, such as flat tempered glass. In an embodiment, a color indicator may be on a main body, such as a portable electronic device or a refrigerator, having a flat surface but not having a groove into which a base layer may be inserted. In this case, among portions of a transparent cover, a portion facing a base layer while overlapping the base layer on the basis of the x-axis may be colored. The base layer may be covered by the colored portion of the transparent cover.

In an embodiment, when a color indicator 54 is on a main body 55 having a curved surface, as shown in FIG. 4, a transparent cover 56 may be made of curved tempered glass or acrylic. In this case, an edge cover 51 may be additionally disposed along an edge of the color indicator 54 and the transparent cover 56 may be on the edge cover 51. The edge cover 51 may press the color indicator 54 in the direction of the main body 55, thereby preventing or reducing gaps each generated by stress between a protection layer, a second electrode layer, an electronic ink layer, and a first electrode layer. For example, the edge cover 51 may include a fixture that is screwed to the main body 55. Among portions of the transparent cover 56, a portion facing the surface of the edge cover 51 through which a screw passes on the basis of the x-axis may be colored. The base layer may be covered by the edge cover 51 and the screw may be hidden by the colored portion of the transparent cover 56. In an embodiment, in the case of a wearable module where the main body 55 is worn on the user's body, the main body 55 may be formed of a flexible material. Change in the shape of the main body 55 may raise a concern that the color indicator 54 is wrinkled. To prevent or reduce a chance of such an issue, a core may be between the main body 55 and the color indicator 54. The core may be formed of a material that is not easily wrinkled, such as thin plastic. Since the color indicator 54 is on the core, the color indicator 54 may not be easily wrinkled even when the user repeatedly operates.

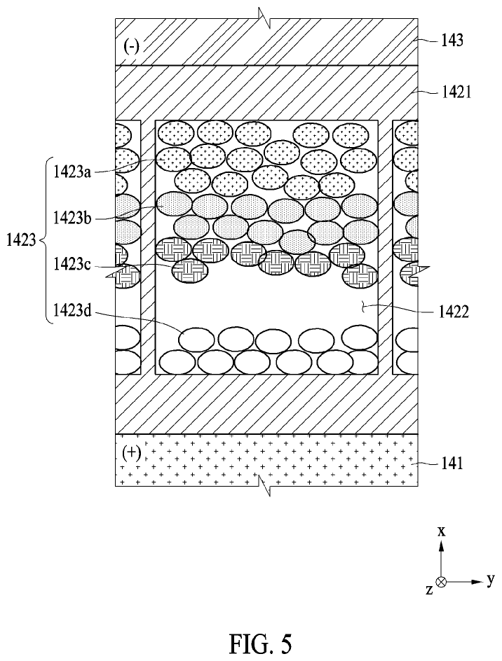

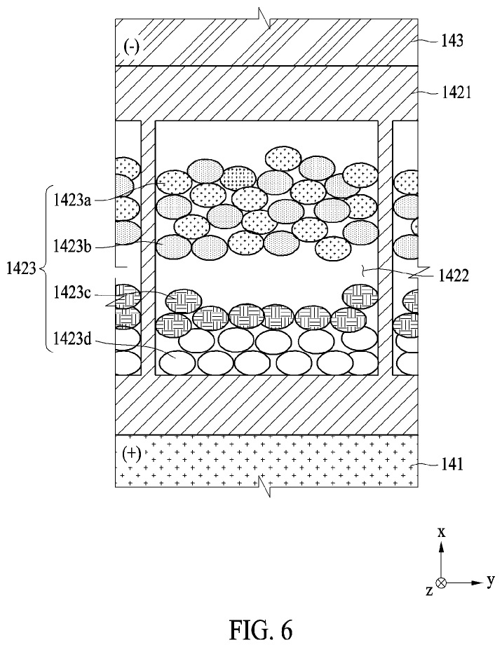

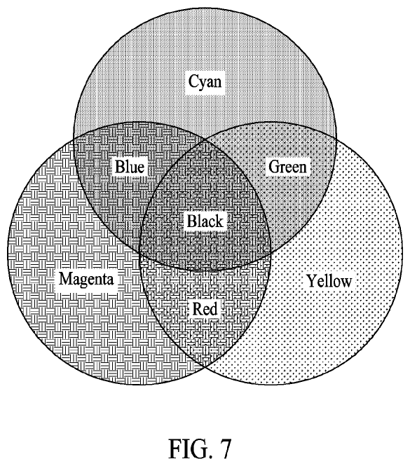

FIGS. 5 and 6 are cross-sectional views illustrating electronic ink layers according to an embodiment and FIG. 7 is a diagram illustrating a synthesized color of cyan, magenta, and yellow according to an embodiment.

Referring to FIGS. 5 to 7, a color indicator according to an embodiment may indicate eight target colors. For example, color particles 1423 may include first color particles 1423a having a magenta color, second color particles 1423b having a cyan color, third color particles 1423c having a yellow color, and fourth color particles 1423d having a white color.

In an embodiment, when certain voltages are applied to a first electrode layer 141 and to a second electrode layer 143, the color that the color indicator indicates may be changed by using the slight difference in the moving direction and moving velocity of the color particles 1423. After the color particles 1423 move by a specific range, the movement of the color particles 1423 may be limited by the viscosity of the transparent fluid 1422 and the color of the color indicator may be maintained. An electronic device may consume power only when a color controller changes voltages of the first electrode layer 141 and the second electrode layer 143.

In an embodiment, the moving direction and moving velocity of the color particles 1423 may vary depending on a color. For example, the mass or electric charge amount of the color particles 1423 may vary depending on a color of the color particles 1423. For example, the first color particles 1423a, the second color particles 1423b, and the third color particles 1423c may have a positive charge and the fourth color particles 1423d may have a negative charge.

As shown in FIG. 6, the voltages of the first electrode layer 141 and the second electrode layer 143 may be controlled so that the color particles 1423 may be positioned on different layers based on the height direction of the frame 1421. Here, the height direction of the frame 1421 may be the x-axis direction. The color indicator may indicate the color of the first color particles 1423a.

As shown in FIG. 7, voltages of the first electrode layer 141 and the second layer 143 may be finely controlled so as to cause the first color particles 1423a and the second color particles 1423b to be mixed and positioned on the same layer based on the height direction of the frame 1421. For example, the magnitude of a voltage applied to the first electrode layer 141 may be reduced compared to the case where the color particles 1423 are on different layers based on the height direction of the frame 1421. The color indicator may indicate a color in which two colors are mixed. The color indicator may represent eight colors including white in seven colors that may be generated by mixing magenta, yellow, and cyan. The type of the color particles 1423 is described as four herein, but examples are not necessarily limited thereto.

Referring back to FIGS. 1 and 2, the electronic device 1 according to an embodiment may further include a solar charger 17. The solar charger 17 may supply power required to control voltages applied to a first electrode layer and a second electrode layer. As described above, the electronic device 1 may consume power only when the color of the color indicator 14 changes. For example, power consumed during a color change may be 1.5 mW. The use of the solar charger 17 may require no separate charging model and may allow the electronic device 1 to be used until the disposal of the electronic device 1. The solar charger 17 may include a solar panel 171 and a solar battery 172.

In an embodiment, the solar panel 171 may be on the outer surface of the main body 15. The solar panel 171 may absorb light from sunlight and indoor lighting and convert the light into electrical energy. Electrical energy generated from the solar panel 171 may be stored in the solar battery 172. The solar battery 172 may store electrical energy and supply electrical energy when voltages applied to the first electrode layer and the second electrode layer change.

In an embodiment, the input unit 11 may detect charging information of the solar battery 172. For example, the input unit 11 may detect whether the solar battery 172 is being charged, a charge amount, and the like and transmit information thereabout to the color determiner 12. In an embodiment, the electronic device 1 may use only the solar battery 172 without separately using the battery 113. The color determiner 12 may determine a target color based on the received information.

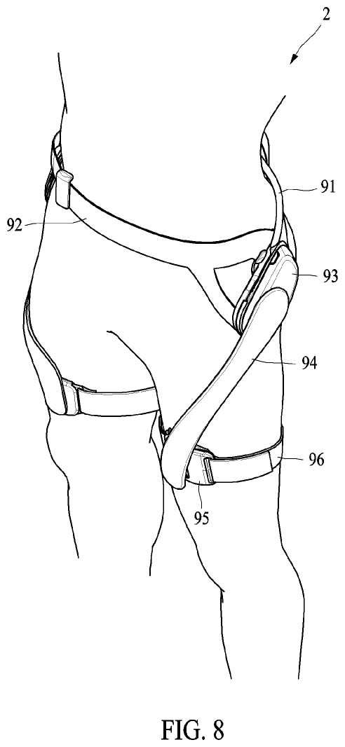

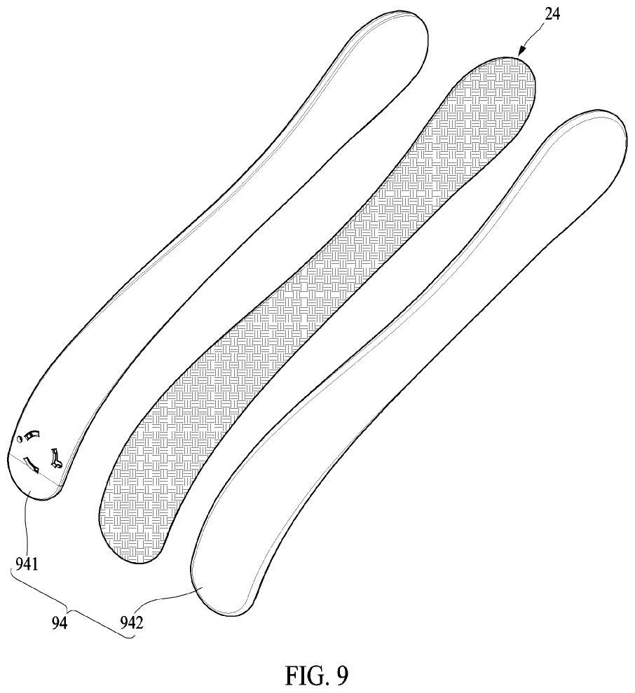

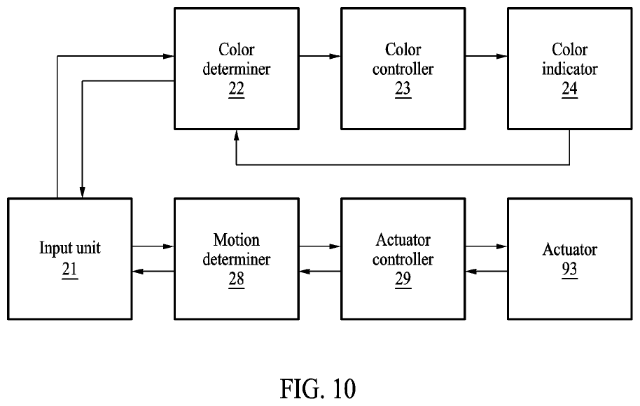

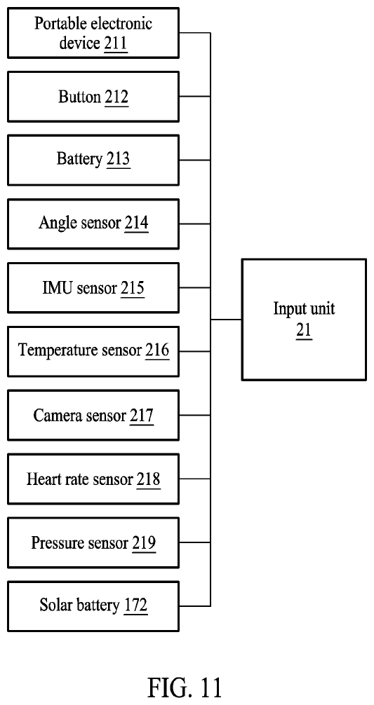

FIG. 8 is a perspective view illustrating a user wearing a motion assist apparatus according to an embodiment. FIG. 9 is a perspective view illustrating a drive frame body, a drive frame cover, and a color indicator according to an embodiment. FIG. 10 is a block diagram schematically illustrating an actuator control mechanism and a color change mechanism of a motion assist apparatus according to an embodiment. FIG. 11 is a block diagram schematically illustrating a configuration of an input unit according to an embodiment.

Referring to FIGS. 8 to 11, a motion assist apparatus 2 (hereinafter, referred to as “motion assist apparatus”) having a color change function using electronic ink, according to an embodiment, is worn by a user to assist the user's exercise. The user may be a human or a robot but is not limited thereto. The motion assist apparatus 2 may assist motion of some joints of the user in the upper or lower body. For example, the motion assist apparatus 2 may assist the motion of the user's lower body by assisting at least one of a hip joint, knee joint, and ankle joint of the user. The motion assist apparatus 2 may include a waist wearable part, a thigh wearable part, an actuator 93, and a drive frame 94.

In an embodiment, the waist wearable part and the thigh wearable part may be opposite to each other based on one body part of the user and may be worn on a proximal part and a distal part, respectively. For example, the waist wearable part may cover the waist and/or the pelvis and the thigh wearable part may cover the thighs, knees, calves, and/or feet.

The waist wearable part may include a waist frame 91 that surrounds a part of the user's waist and a waist belt 92 that connects to the waist frame 91 and surrounds the remaining part of the user's waist. For example, the waist frame 91 may wrap around the back of the waist and the waist belt 92 may wrap around the front of the waist.

The thigh wearable part may include a force transmission frame 95 that surrounds a part of the user's thigh and a thigh belt 96 that connects to the force transmission frame 95 and surrounds the remaining part of the user's thigh. For example, the force transmission frame 95 may wrap around the front of the thigh.

In an embodiment, the waist wearable part and the thigh wearable part may relatively move on a sagittal plane. For example, when the user wearing the motion assist apparatus 2 flexes or extends their hip joint, the thigh wearable part may rotate relative to the waist wearable part on the sagittal plane.

In an embodiment, the waist wearable part and the thigh wearable part may relatively move on a frontal plane. For example, when the user wearing the motion assist apparatus 2 adducts or abducts their hip joint, the thigh wearable part may rotate relative to the waist wearable part on the frontal plane.

In an embodiment, the drive frame 94 and the waist wearable part may move relative to each other on a transverse plane. For example, when the user wearing the motion assist apparatus 2 rotates their thigh, the waist wearable part, which is in close contact with the thigh of the user, may rotate together with the thigh of the user. The thigh wearable part may relatively rotate with respect to the drive frame 94. According to this structure, the wearing comfort of the motion assist apparatus 2 may improve.

In an embodiment, the actuator 93 may connect to the waist frame 91 and generate power. The actuator 93 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an embodiment, the drive frame 94 may transmit power generated by the actuator 93 to the force transmission frame 95. For example, the drive frame 94 may assist the motion of the user's hip joint. When an output end of the actuator 93 rotates in one direction, the drive frame 94 may receive power from the actuator 93 and assist flexion of the user's hip joint. When the output end of the actuator 93 rotates in an opposite direction to the one direction, the drive frame 94 may receive power from the actuator 93 and assist extension of the user's hip joint. The drive frame 94 is described as assisting the motion of the user's hip joint but a function of the drive frame 94 is not limited thereto. For example, when the motion assist apparatus 2 is used to assist the motion of joints in the user's upper body, the drive frame 94 may assist the motion of a shoulder or elbow joint of the user.

In an embodiment, the motion assist apparatus 2 may indicate various colors according to the user's conditions or surrounding conditions through a color indicator 24. For example, the color indicator 24 may be on at least one of the waist belt 92, the actuator 93, the drive frame 94, the force transmission frame 95, and the thigh belt 96. In order to prevent or reduce a chance of the color indicator 24 from being damaged by an external force or by contact of a foreign substance during the user's exercise, the color indicator 24 may be protected by a cover. For example, the drive frame 94 may include a drive frame body 941 covering a portion of the user's thigh and a drive frame cover 942 connecting to the drive frame body 941. The color indicator 24 may be between at least the drive frame body 941 and the drive frame cover 942.

In an embodiment, the drive frame body 941 may be formed of a light and hard material. For example, the drive frame body 941 may be formed of high rigidity reinforced plastic. Since the color indicator 24 is supported by the drive frame body 941, the color indicator 24 may not be wrinkled even when the user performs repetitive motion. The drive frame cover 942 may be formed of a transparent and hard material. For example, the drive frame cover 942 may be formed of transparent plastic, such as polycarbonate.

In an embodiment, the drive frame 94 may include a plurality of frames so that the user may flexibly move their joints. For example, the drive frame 94 may include a frame connecting to the actuator 93 and a frame connecting to the thigh belt 96. In this case, the color indicator 24 may be in each of frames.

In an embodiment, the user may intuitively check the state of the motion assist apparatus 2 through a color indicated by the color indicator 24. For example, the color indicator 24 may indicate different colors according to driving modes of the motion assist apparatus 2, such as an assistance mode and a fitness mode. For example, the color indicator 24 may indicate different colors according to the remaining battery power and charge state of the motion assist apparatus 2. For example, when an external device, such as a portable electronic device, is paired with the motion assist apparatus 2, the color indicator 24 may be turned on.

In an embodiment, the user may intuitively check the user's status through a color indicated by the color indicator 24. For example, when the user achieves a target amount of exercise, the color indicator 24 may be turned on.

In an embodiment, the user may select a preferred color depending on clothing conditions, the weather, and the like. User experience of the motion assist apparatus 2 may increase. The motion assist apparatus 2 may further include an input unit 21, a color determiner 22, a color controller 23, a color indicator 24, a motion determiner 28, and an actuator controller 29. Unless otherwise specified, details of the input unit 21, the color determiner 22, the color controller 23, and the color indicator 24 may be the same as those of the input unit 11, the color determiner 12, the color controller 13, and the color indicator 14 of FIG. 2.

In an embodiment, the input unit 21 may detect at least one or more of exercise information, body information, and clothing information with respect to the user. The input unit 21 may transmit the detected information to the color determiner 22 and the motion determiner 28.

In an embodiment, the motion determiner 28 may store information about the magnitude and time interval of force applied according to the type of motion or the angle of the user's joint. In an embodiment, the motion determiner 28 may be on the actuator 93 but the position of the motion determiner 28 is not necessarily limited thereto. The motion determiner 28 may compare stored information to the information received from the input unit 21 to determine the user's exercise type and intensity. The motion determiner 28 may transmit information about the type and intensity of motion to the actuator controller 29 so that the actuator 93 may change to a driving state suitable for the user's exercise conditions.

In an embodiment, the actuator controller 29 may control the driving state of the actuator 93 by controlling a current applied to the actuator 93. In an embodiment, the actuator controller 29 may be on the actuator 93 but the position of the actuator controller 29 is not necessarily limited thereto. A change in the driving state of the actuator 93 may change the force, joint angle, and the like that are required to be applied in order for the user to perform the same motion. The user's exercise efficiency may increase.

In an embodiment, after the driving state is controlled in the actuator 93, information about the changed driving state may be transmitted to the input unit 21. The input unit 21 may transfer information about the changed driving state to the color determiner 22 again. The color determiner 22 may determine a target color corresponding to the changed driving state. The color of the color indicator 24 may change to a target color corresponding to the changed driving state.

In an embodiment, the input unit 21 may include an angle sensor 214 (e.g., see FIG. 11). The angle sensor 214 may sense the user's joint angle. For example, the angle sensor 214 may be on at least one of the drive frame 94, the force transmission frame 95, and the thigh belt 96. For example, the angle sensor 214 may sense an angle between the waist and the thigh when the user flexes or extends their hip joint on the sagittal plane. The angle sensor 214 may detect an angle between the waist and the thigh when the hip joint is adducted or abducted on the coronal plane.

In an embodiment, the color determiner 22 may determine a target color of the color indicator 24 based on the information detected by the angle sensor 214. The color determiner 22 may determine a different target color according to the magnitude of an angle. In the case of a reference line that is a line perpendicular to the ground on the sagittal plane, when the angle between the user's thigh and the reference line is less than 30 degrees, greater than or equal to 30 degrees and less than 70 degrees, or greater than or equal to 70 degrees, the color determiner 22 may determine, for example, a target color to be green, yellow, or red, respectively. The color indicated by the color indicator 24 may be changed to a target color by the color controller 23 controlling voltage.

In an embodiment, the input unit 21 may further include an inertial measurement unit (IMU) sensor 215. The IMU sensor 215 may sense acceleration of the user's body. For example, the IMU sensor 215 may be on at least one of the drive frame 94, the force transmission frame 95, and the thigh belt 96. For example, the IMU sensor 215 may measure the angular velocity or gait acceleration of the user's joint while the user is walking with the motion assist apparatus 2 worn on. The IMU sensor 215 may transmit measured information to the color determiner 22 and the motion determiner 28.

In an embodiment, the color determiner 22 may determine a target color of the color indicator 24 based on the information measured by the IMU sensor 215. The color determiner 22 may determine different target colors according to magnitudes of acceleration and angular velocity. For example, when the angular velocity of the user's thigh is less than 1.05 rad/s, greater than or equal to 10.5 rad/s and less than 2.625 rad/s, or greater than or equal to 2.625 rad/s, the color determiner 22 may determine a target color to be green, yellow, or red, respectively. The color indicated by the color indicator 24 may be changed to a target color by the color controller 23 controlling voltage.

In an embodiment, the motion determiner 28 may determine the type or state of the user's exercise based on information measured by the IMU sensor 215. For example, the motion determiner 28 may compare the user's joint angular velocity detected by the IMU sensor 215 to a pre-stored average joint angular velocity of the user to determine the user's exercise intensity. The motion determiner 28 may transmit information about the exercise intensity to the actuator controller 29.

In an embodiment, the actuator controller 29 may increase the magnitude of power generated by the actuator 93 when, for example, the user's joint angular velocity is less than 2.625 rad/s. The magnitude of force required for the user to perform the same motion may reduce. The user's motion velocity may increase.

In an embodiment, the actuator controller 29 may reduce the magnitude of the power generated by the actuator 93 when, for example, the user's joint angular velocity is 2.625 rad/s or more. The magnitude of force required for the user to perform the same motion may increase. The user's motion velocity may decrease.

Herein, it is described that a boundary value based on which the motion determiner 28 determines the user's exercise intensity is the same as the boundary value based on which the color determiner 22 determines a target color. However, the boundary values may be different from each other.

In an embodiment, the input unit 21 may include a portable electronic device 211, a button 212, and a battery 213 and may further include at least one of a temperature sensor 216 that senses the user's body temperature, a camera sensor 217 that senses the user's clothing information, a heart rate sensor 218 that measures the user's heart rate, and a pressure sensor 219 that senses the press pressure of the user's thigh on the force transmission frame 95 (e.g., see FIGS. 8, 11). Here, the camera sensor 217 may refer to any sensor that visually senses clothing information of the user, such as a clothing color. For example, a camera in the portable electronic device 211 may also be included in the camera sensor 217. In particular, when the user photographs their clothing state with a camera of the portable electronic device 211, the portable electronic device 211 may analyze a clothing color and recommend at least two target colors suitable for the clothing color.

In an embodiment, the motion assist apparatus 2 may further include a solar charger (e.g., the solar charger 17 of FIG. 1). The solar charger may include a solar panel (e.g., the solar panel 171 of FIG. 1) on the outer surface of at least one of the waist frame 91, the waist belt 92, and the thigh belt 96 and may include a solar battery (e.g., the solar battery 172 of FIG. 1) that stores energy generated from the solar panel. The input unit 21 may sense charge information of the solar battery.

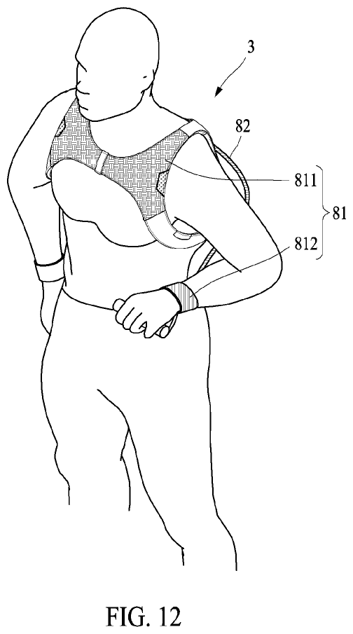

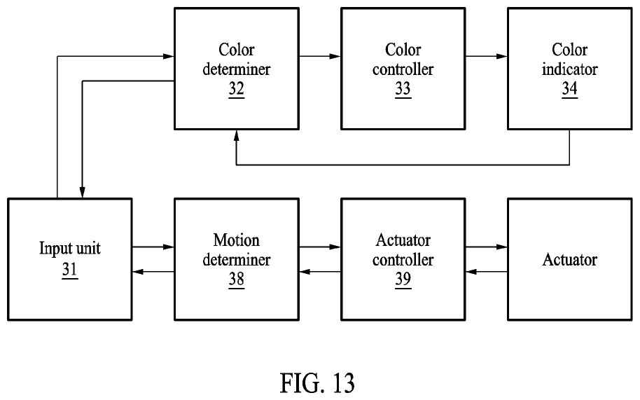

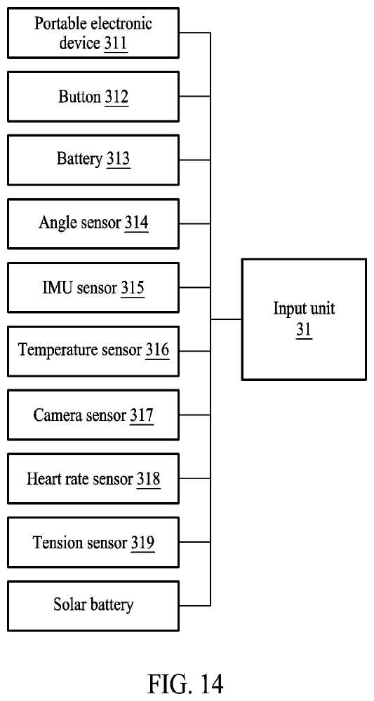

FIG. 12 is a perspective view illustrating a user wearing a motion assist apparatus according to an embodiment. FIG. 13 is a block diagram schematically illustrating an actuator control mechanism and a color change mechanism of an exercise apparatus, according to an embodiment. FIG. 14 is a block diagram schematically illustrating a configuration of an input unit according to an embodiment.

Referring to FIGS. 12 to 14, an exercise apparatus 3 (hereinafter, referred to as an “exercise apparatus”) having a color change function using electronic ink, according to an embodiment, may be worn on a user's upper body. Without an additional exercise device, the user may stimulate their target body part even in a narrow space by using the exercise apparatus 3. The exercise apparatus 3 may indicate various colors according to the user's conditions or surrounding conditions through a color indicator 34. The user may intuitively check states of the exercise apparatus 3 and the user through a color indicated by the color indicator 34. The exercise apparatus 3 may include a wearable module 81, a cable 82, an actuator, an input unit 31, a color determiner 32, a color controller 33, and a color indicator 34. In addition, the exercise apparatus 3 may further include a motion determiner 38 and an actuator controller 39.

In an embodiment, unless otherwise specified, the details of the input unit 31, the color determiner 32, the color controller 33, and the color indicator 34 may be the same as those of the input unit 11, the color determiner 12, the color controller 13, and the color indicator 14 of FIG. 2, respectively. In addition, unless otherwise specified, the details of the motion determiner 38 and the actuator controller 39 may be the same as those of the motion determiner 28 and the actuator controller 29 of FIG. 10, respectively. Each “controller” and “determiner” herein may comprise processing circuitry, and each may be part of at least one processor for example.

In an embodiment, the wearable module 81 may be worn on the user's upper body. The wearable module 81 may include a plurality of modules worn on various parts of the user's upper body. For example, the wearable module 81 may include a chest wearable module 811, which is worn on the user's chest, and a pair of wrist wearable modules 812, which is worn on both wrists of the user. In an embodiment, the wearable module 81 may additionally include an upper arm wearable module worn on the upper arm of the user. Thus, the wearable module may comprise at least one wearable support and/or frame.

In an embodiment, the cable 82 may connect to the wearable module 81. For example, the cable 82 may be provided as a pair. One end of the cable 82 may connect to a portion of the chest wearable module 811 covering the user's back among portions of the chest wearable module 811. The other end of cable 82 may connect to the wrist wearable module 812.

In an embodiment, the user may stimulate a desired muscle by repeatedly performing an operation of pulling the cable 82. For example, at least a portion of the cable 82 may be formed of a material having elasticity. One end of the cable 82 may connect to a spool. As the cable 82 winds around or unwinds from the spool, tension acting on the cable 82 may be adjusted. The actuator may be on the chest wear module 811 and may adjust an exercise intensity by controlling the rotation direction and rotation velocity of the spool. The actuator and the spool may be on a portion of the chest wearable module 811 that covers the user's back among portions of the chest wearable module 811.

In an embodiment, as the wrist wearable module 812 moves away from the chest wearable module 811, the cable 82 may increase in length as the cable 82 unwinds from the spool. Subsequently, when the user gradually reduces force that pulls the cable 82, the length of the cable 82 may be restored while being wound around the spool and the wrist wearable module 812 may be closer to the chest wearable module 811. The user may change an angle, which pulls the cable 82, and the relative position of the wrist wearable module 812 with respect to the chest wearable module 811, thereby stimulating muscles in a target body part. In order to prevent or reduce concentration of force on the user's wrist, a graspable handle may be on the wrist wearable module 812.

In an embodiment, the input unit 31 may detect at least one of the user's body information, the user's clothing information, and information about tension applied to the cable 82. The information detected by the input unit 31 may be transmitted to the color determiner 32 and the motion determiner 38. The color controller 33 may change the color of the color indicator 34 to a target color.

In an embodiment, the color indicator 34 may be on the wearable module 81. For example, the color indicator 34 indicating a target color for the user's heart rate may be on the chest wearable module 811. For example, the color indicator 34 indicating a target color for the tension of the cable 82 may be on the wrist wearable module 812. Additionally, the color indicator 34 on the wrist wearable module 812 may indicate the moving direction of the user's arm as an arrow by using a distinct color to guide a correct exercise posture.

In an embodiment, in order to prevent or reduce a chance of the color indicator 34 from being excessively wrinkled during the user's exercise, an edge cover (e.g., the edge cover 51 of FIG. 4) may be on the edge of the color indicator 34 and a transparent cover (e.g., the transparent cover 56 of FIG. 4) may be on the edge cover. Additionally, a core may be between at least the color indicator 34 and the wearable module 81.

In an embodiment, the input unit 31 may include a tension sensor 319. The tension sensor 319 may detect the amount of tension acting on the cable 82. For example, the tension sensor 319 may be on the cable 82. The tension sensor 319 may transmit detected information to the color determiner 32.

In an embodiment, the color determiner 32 may determine a target color of the color indicator 34 based on the information detected by the tension sensor 319. The color determiner 32 may determine a different target color according to the magnitude of tension. For example, when the tension applied to the cable 82 is less than 20 N, greater than or equal to 20 N and less than 50 N, greater than or equal to 50 N and less than 80 N, or greater than or equal to 80 N, the color determiner 32 may determine a target color to be yellow, magenta, blue, or black, respectively. The color indicated by the color indicator 34 may be changed to a target color by the color controller 33 controlling voltage.

In an embodiment, the motion determiner 38 may determine the type or state of the user's exercise based on information sensed by the tension sensor 319. For example, the motion determiner 38 may compare the cable tension detected by the tension sensor 319 to a pre-stored cable tension to determine the user's exercise intensity. The motion determiner 38 may transmit information about the exercise intensity to the actuator controller 39.

In an embodiment, the actuator controller 39 may adjust the user's exercise intensity. For example, when the tension acting on the cable 82 is less than 20 N, the actuator controller 39 may reduce the magnitude of power generated by the actuator. The rotation velocity of the spool may decrease and the velocity at which the cable 82 winds around or unwinds from the spool may also decrease. The magnitude of force required for the user to pull the cable 82 may increase and the user's exercise intensity may increase.

In an embodiment, the input unit 31 may further include a heart rate sensor 318. The heart rate sensor 318 may sense the heart rate of the user. For example, the heart rate sensor 318 may be on the wrist wearable module 812 that contacts the user's skin. The heart rate sensor 318 may transmit a detected heart rate to the color determiner 32.

In an embodiment, the color determiner 32 may determine a target color of the color indicator 34 based on the heart rate detected by the heart rate sensor 318. The color determiner 32, which may comprise processing circuitry, may determine a different target color according to a heart rate. For example, when the heart rate is greater than or equal to 60 bpm and less than 80 bpm, greater than or equal to 81 bpm and less than 100 bpm, greater than or equal to 101 bpm and less than 120 bpm, or greater than or equal to 121 bpm and less than 140 bpm, the color determiner 32 may determine a target color to be green, cyan, yellow, or red, respectively. The color indicated by the color indicator 34 may be changed to a target color by the color controller 33 controlling voltage.

In an embodiment, when the actuator controller 39 determines that the user's heart rate is high, the actuator controller 39 may increase the magnitude of power generated by the actuator to reduce an exercise intensity. The rotation velocity of the spool may increase and the velocity at which the cable 82 winds around or unwinds from the spool may increase. The magnitude of force required for the user to pull the cable 82 may decrease and the user's exercise intensity may decrease.

In an embodiment, the input unit 31 may include a portable electronic device 311, a button 312, a battery 313 and may further include at least one of: circuitry, an angle sensor 314, an IMU sensor 315, a temperature sensor 316, and a camera sensor 317. Since the description of each sensor is redundant, a description thereof is omitted.

In an embodiment, the exercise apparatus 3 may further include a solar charger (e.g., the solar charger 17 of FIG. 1). The solar charger may include a solar panel (e.g., the solar panel 171 in FIG. 1) on the outer surface of the wearable module 81 and a solar battery (e.g., the solar battery 172 of FIG. 1). The input unit 31 may include at least one sensor and/or circuitry to detect charge information of the solar battery.

According to an embodiment, a motion assist apparatus having a color change function using electric ink may include a waist frame and a waist belt that are worn on a waist of a user, a force transmission frame and a thigh belt that are worn on a thigh of the user, an actuator connected, directly or indirectly, to the waist frame and configured to generate power, a drive frame connected, directly or indirectly, to the actuator and configured to transmit the power to the force transmission frame, an input unit configured to detect at least one of exercise information of the user, body information of the user, and clothing information of the user, a color indicator including a first electrode layer disposed on, directly or indirectly, the drive frame, an electronic ink layer disposed on, directly or indirectly, the first electrode layer, and a second electrode layer disposed on, directly or indirectly, the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

In an embodiment, the input unit may be disposed on, directly or indirectly, at least one of the drive frame, the force transmission frame, and the thigh belt and may include an angle sensor configured to sense a joint angle of the user.

In an embodiment, the color determiner may be configured to determine the target color to be a first color when the joint angle of the user is less than a first angle and determine the target color to be a second color when the joint angle of the user is greater than or equal to the first angle.

In an embodiment, the color determiner may be configured to determine the target color to be a third color when the joint angle of the user is greater than a second angle.

In an embodiment, the motion assist apparatus may further include a motion determiner configured to determine an exercise state of the user based on the exercise information of the user and an actuator controller configured to receive information about the exercise state of the user from the motion determiner and control the actuator.

In an embodiment, the input unit may be disposed on, directly or indirectly, at least one of the drive frame, the force transmission frame, and the thigh belt and further include an IMU sensor configured to sense an angular velocity of a joint of the user.

In an embodiment, the color determiner may be configured to determine the target color to be a fourth color when the angular velocity of the joint of the user is less than a first angular velocity and determine the target color to be a fifth color when the angular velocity of the joint of the user is greater than or equal to the first angular velocity.

In an embodiment, the actuator controller may be configured to increase a magnitude of power generated by the actuator when the angular velocity of the joint of the user is less than a first angular velocity and decrease the magnitude of the power generated by the actuator when the angular velocity of the joint of the user is greater than or equal to the first angular velocity.

In an embodiment, the first electrode layer may include a substrate layer having a flexible material and an application layer applied to the substrate layer.

In an embodiment, the application layer may be formed of conductive ink.

In an embodiment, the drive frame may include a drive frame body configured to cover a portion of the thigh of the user and a drive frame cover connected, directly or indirectly, to the drive frame body, and the color indicator may be provided between at least the drive frame body and the drive frame cover.

In an embodiment, the motion assist apparatus may further include a solar charger configured to supply power required to control the voltage applied to the first electrode layer and the voltage applied to the second electrode layer.

In an embodiment, the solar charger may include a solar panel disposed on, directly or indirectly, an outer surface of at least one of the waist frame, the waist belt, and the thigh belt and a solar battery configured to store energy generated from the solar panel, and the input unit may be configured to detect charge information of the solar battery.

In an embodiment, the color indicator may be flexible.

In an embodiment, the input unit may include at least one of a temperature sensor configured to sense a temperature of the user, a camera sensor configured to sense the clothing information of the user, and a heart rate sensor configured to measure a heart rate of the user.

According to an embodiment, an exercise apparatus having a color change function using electronic ink may include a wearable module worn on an upper body of a user, a cable connected, directly or indirectly, to the wearable module, an input unit configured to detect at least one of body information of the user, clothing information of the user, and information about tension applied to the cable, a color indicator including a first electrode layer disposed on, directly or indirectly, the wearable module, an electronic ink layer disposed on, directly or indirectly, the first electrode layer, and a second electrode layer disposed on, directly or indirectly, the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer. “Based on” as used herein covers based at least on.

In an embodiment, the input unit may be disposed on, directly or indirectly, the cable and configured to detect a magnitude of tension applied to the cable.

In an embodiment, the color determiner may be configured to determine the target color to be a first color when the tension applied to the cable is less than first tension and determine the target color to be a second color when the tension applied to the cable is greater than or equal to the first tension.

In an embodiment, the color determiner may be configured to determine the target color to be a third color when the tension applied to the cable is equal to or greater than second tension.

Each embodiment herein may be used in combination with any other embodiment(s) described herein.

According to an embodiment, an electronic device having a color change function using electronic ink may include a main body, an input unit configured to detect at least one of a driving state of the electronic device, a surrounding environment of the electronic device, and information about a preferred color of a user, a color indicator including a first electrode layer disposed on the main body, an electronic ink layer disposed on the first electrode layer, and a second electrode layer disposed on the electronic ink layer, a color determiner configured to determine a target color of the color indicator based on information detected by the input unit, and a color controller configured to receive information about the target color from the color determiner and control a voltage applied to the first electrode layer and a voltage applied to the second electrode layer so as to change a color of the electronic ink layer.

In an embodiment, the features of the foregoing embodiments may be combined unless technically obviously impossible.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A motion assist apparatus including a color change function, the motion assist apparatus comprising:
a waist frame and a waist belt configured to be worn proximate a waist of a user;
a force transmission frame and a thigh belt configured to be worn on a thigh of the user;
an actuator, comprising a motor, connected to the waist frame and configured to generate power;
a drive frame connected to the actuator and configured to transmit the power to at least the force transmission frame;
an input unit, comprising circuitry and/or at least one sensor, configured to detect at least one of exercise information of the user, body information of the user, and clothing information of the user;
a color indicator comprising a first electrode layer disposed on the drive frame, an electronic ink layer disposed on the first electrode layer, and a second electrode layer disposed on the electronic ink layer, so that the electronic ink layer is located between at least the first electrode layer and the second electrode layer;
a color determiner, comprising circuitry, configured to determine a target color of the color indicator based on information detected by the input unit; and
a color controller, comprising circuitry, configured to receive information about the target color from the color determiner and control a voltage to be applied to the first electrode layer and a voltage to be applied to the second electrode layer so as to change a color of the electronic ink layer.

2. The motion assist apparatus of claim 1, wherein the input unit is disposed on at least one of the drive frame, the force transmission frame, and the thigh belt, and wherein the input unit comprises an angle sensor configured to sense a joint angle of the user.

3. The motion assist apparatus of claim 2, wherein the color determiner is configured to determine the target color to be a first color when the joint angle of the user is less than a first angle and to determine the target color to be a second color when the joint angle of the user is greater than or equal to the first angle.

4. The motion assist apparatus of claim 3, wherein the color determiner is configured to determine the target color to be a third color when the joint angle of the user is greater than a second angle.

5. The motion assist apparatus of claim 1, further comprising:
a motion determiner, comprising circuitry and/or a sensor, configured to determine an exercise state of the user based on the exercise information of the user; and
an actuator controller, comprising circuitry, configured to receive information about the exercise state of the user from the motion determiner and control the actuator.

6. The motion assist apparatus of claim 5, wherein the input unit is disposed on at least one of the drive frame, the force transmission frame, and the thigh belt, and wherein the input unit further comprises an inertial measurement unit (IMU) sensor configured to sense an angular velocity of a joint of the user.

7. The motion assist apparatus of claim 6, wherein the color determiner is configured to determine the target color to be a fourth color when the angular velocity of the joint of the user is less than a first angular velocity and to determine the target color to be a fifth color when the angular velocity of the joint of the user is greater than or equal to the first angular velocity.

8. The motion assist apparatus of claim 6, wherein the actuator controller is configured to increase a magnitude of power generated by the actuator when the angular velocity of the joint of the user is less than a first angular velocity, and to decrease the magnitude of the power generated by the actuator when the angular velocity of the joint of the user is greater than or equal to the first angular velocity.

9. The motion assist apparatus 1, wherein the first electrode layer comprises:
a substrate comprising flexible material; and
an application layer supported by the substrate.

10. The motion assist apparatus of claim 9, wherein the application layer comprises conductive ink.

11. The motion assist apparatus of claim 1, wherein the drive frame comprises:
a drive frame body configured to cover a portion of the thigh of the user; and
a drive frame cover connected to the drive frame body, and
wherein the color indicator is provided between at least the drive frame body and the drive frame cover.

12. The motion assist apparatus of claim 1, further comprising a solar charger configured to supply power to control the voltage applied to the first electrode layer and the voltage applied to the second electrode layer.

13. The motion assist apparatus of claim 12, wherein
the solar charger comprises:
a solar panel disposed on an outer surface of at least one of the waist frame, the waist belt, and the thigh belt; and
a solar battery configured to store energy generated from the solar panel, and
wherein the input unit is configured to detect charge information of the solar battery.

14. The motion assist apparatus of claim 1, wherein the color indicator is flexible.

15. The motion assist apparatus of claim 1, wherein the input unit comprises at least one of a temperature sensor configured to sense a temperature of the user, a camera sensor configured to sense the clothing information of the user, and a heart rate sensor configured to measure a heart rate of the user.

16. A wearable exercise apparatus with a color change function based on electronic ink, the exercise apparatus comprising:
a wearable module, comprising at least one frame and/or support, configured to be worn on an upper body of a user;
a cable connected to the wearable module;
an input unit, comprising circuitry and/or at least one sensor, configured to detect at least one of body information of the user, clothing information of the user, and information about tension applied to the cable;
a color indicator comprising a first electrode layer disposed on the wearable module, an electronic ink layer disposed on the first electrode layer, and a second electrode layer disposed on the electronic ink layer;
a color determiner, comprising circuitry, configured to determine a target color of the color indicator based on information detected by the input unit; and
a color controller, comprising circuitry, configured to receive information about the target color and control a voltage to be applied to the first electrode layer and a voltage to be applied to the second electrode layer so as to change a color of the electronic ink layer.

17. The exercise apparatus of claim 16, wherein the input unit is disposed on the cable and configured to detect a magnitude of tension applied to the cable.

18. The exercise apparatus of claim 17, wherein the color determiner is configured to determine the target color to be a first color when the tension applied to the cable is less than first tension, and to determine the target color to be a second color when the tension applied to the cable is greater than or equal to the first tension.

19. The exercise apparatus of claim 18, wherein the color determiner is configured to determine the target color to be a third color when the tension applied to the cable is equal to or greater than second tension.

20. An electronic device comprising:
a main body, comprising a frame and/or support, to be worn by a user;
an input unit, comprising circuitry and/or at least one sensor, configured to detect at least one of a driving state of the electronic device, a surrounding environment of the electronic device, and information about a preferred color of a user;
a color indicator comprising a first electrode layer disposed on the main body, an electronic ink layer disposed on the first electrode layer, and a second electrode layer disposed on the electronic ink layer, so that the electronic ink layer is located between at least the first electrode layer and the second electrode layer;
a color determiner, comprising circuitry, configured to determine a target color of the color indicator based on information detected by the input unit; and
a color controller, comprising circuitry, configured to receive information about the target color from the color determiner and control a voltage to be applied to the first electrode layer and a voltage to be applied to the second electrode layer so as to change a color of the electronic ink layer.
